(19) United States
(12) Patent Application Publication
(10) Pub. No.: US 2024/0160556 A1
(43) Pub. Date: May 16, 2024

(54) AUTO CODE RESOLUTION TRACKING

(71) Applicant: INTERNATIONAL BUSINESS MACHINES CORPORATION, ARMONK, NY (US)

(72) Inventors: Zachary A. Silverstein, Georgetown, TX (US); Jeremy R. Fox, Georgetown, TX (US); Jacob Ryan Jepperson, St. Paul, MN (US); Spencer Thomas Reynolds, Austin, TX (US)

(21) Appl. No.: 18/054,183

(22) Filed: Nov. 10, 2022

(51) Int. Cl. G06F 11/36; G06F 8/65

(52) U.S. Cl. CPC G06F 11/3664; G06F 8/65

(57) ABSTRACT

A method, computer system, and a computer program product is indicated to provide a solution to a user problem. In one embodiment, this comprises receiving a request from a user for a resolution to a user problem and obtaining a solution to a problem like the user problem from a knowledge-based repository and identifying a source associated with the similar problem. Other solutions are obtained from additional sources like the user problem. A final solution is provided to the user problem by incorporating information from the solutions from the repository and other sources. Information is incorporated to provide a complete resolution to the user problem through the final solutions. A search for any related updates is provided to determines when a similar update needs to be incorporated into the final solution in a future date based on information from the related updates.

### BACKGROUND

The present invention relates generally to the field of data management and more particularly to techniques for managing errors in codes and providing problem resolutions in a timely manner.

Computer software may introduce new features and associated code to existing applications. The collaborative and everchanging nature of these applications at times may cause unintended errors and design flaws in the computer software. In instances, malware may introduce malicious errors intentionally. The process of removing errors or debugging the code can be time consuming and challenging. Sometimes errors may be subtle and cause minor damage. In other instances, errors need to be identified and removed quickly as they nay cause a ripple effect. These ripple effects may have disastrous consequences that can cause computer programs to crash and even damage the hardware.

Some software errors may appear to be common. Due to a variety of reasons, these problems may appear across different platforms and programs in exactly the same way or with slight variations. It would be helpful to become aware of these recurring problems and their causes. It would also be helpful to understand the problem resolution and even incorporate the code and fixes when appropriate.

### SUMMARY

Embodiments of the present invention disclose a method, computer system, and a computer program product for providing a solution to a user problem. In one embodiment, this comprises receiving a request from a user for resolution of a user problem. A knowledge-based repository is searched to identify a previously identified problem and its source that is similar to the user problem. Other sources may also be searched and to identify solutions to similar problems to the user problem. A final solution is then provided to the user problem. This final solution incorporates information from the identified solutions to similar problems from the repository and other sources. Additional components may be provided to the incorporated information to provide a complete resolution to the user problem when the identified solutions do not provide a complete resolution to the user problem. In addition, the method searches for any related updates to any identified solutions from the repository or other sources and determines when a similar update needs to be incorporated into the final solution at a future date.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for providing an auto code resolution and tracking mechanism according to one embodiment; and

FIG. 3 provides a flow diagram detailing an alternate approach taken to the embodiment provided by the flowchart of FIG. 2.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc readonly memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

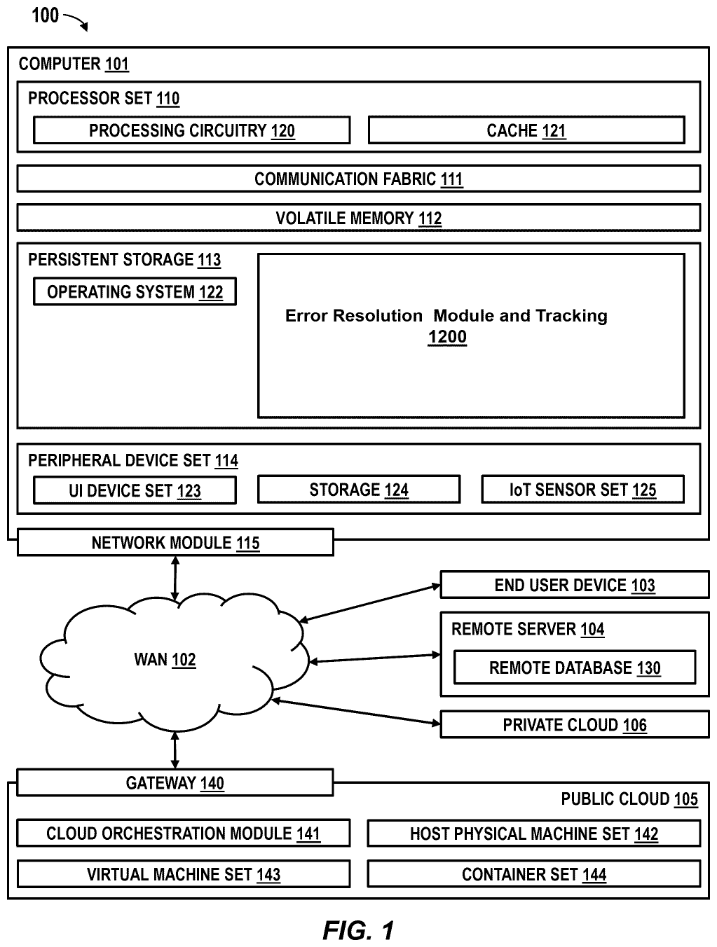

FIG. 1 provides a block diagram of a computing environment 100. The computing environment 100 contains an example of an environment for the execution of at least some of the computer code involved in performing the inventive methods, such as code change differentiator which is capable of providing an error resolution and tracking module (1200). In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A frustrating challenge for designers and software developers may be to provide a bug fix to a code problem. Sometimes, the developer has to search for the resolution to a code problem (hereinafter user problem) that was provided by the same developer or a different developer or developer team. There may also resolutions to common code problems related to particular applications, updates, releases and platforms (not necessarily developed by the user/developer) that may be common across different teams and essential in running the program. The bug fix may be affecting an entire community that use the same platform or application in the same indirect manner. Some of these challenges arise from the large volume of available code (opensource or other), error fixes, releases and applications. The fixes may have been introduced by other teams but it may be difficult to find them. In other instances, the entire solution may not be provided but there may be chunks of code or partial solutions that can still be used to provide a complete solution to a particular problem of the same nature or slightly different nature. It would be then desirous to capture posts, issues and any helpful information that can be used (such as obtained from platforms, repository and forums, among other things) on issues that can lend to a problem resolution and collaborative problem solving. It would also be important to automatically track future builds for manual code inspections. This will help accelerate and secure and validate code cycles as well. Quicker code fixes also help ensure fast security measures. Appropriate measures can be enacted so as to keep development and maintenance cycles aligned. In this way if a user/developer may be looking for a solution to an issue, tracking the same issue across different groups may provide the original user an understanding as to how common the issue may be even if there may be solutions available for the problem. These and other prior art shortcomings may be provided in techniques below that address providing resolutions to user problems.

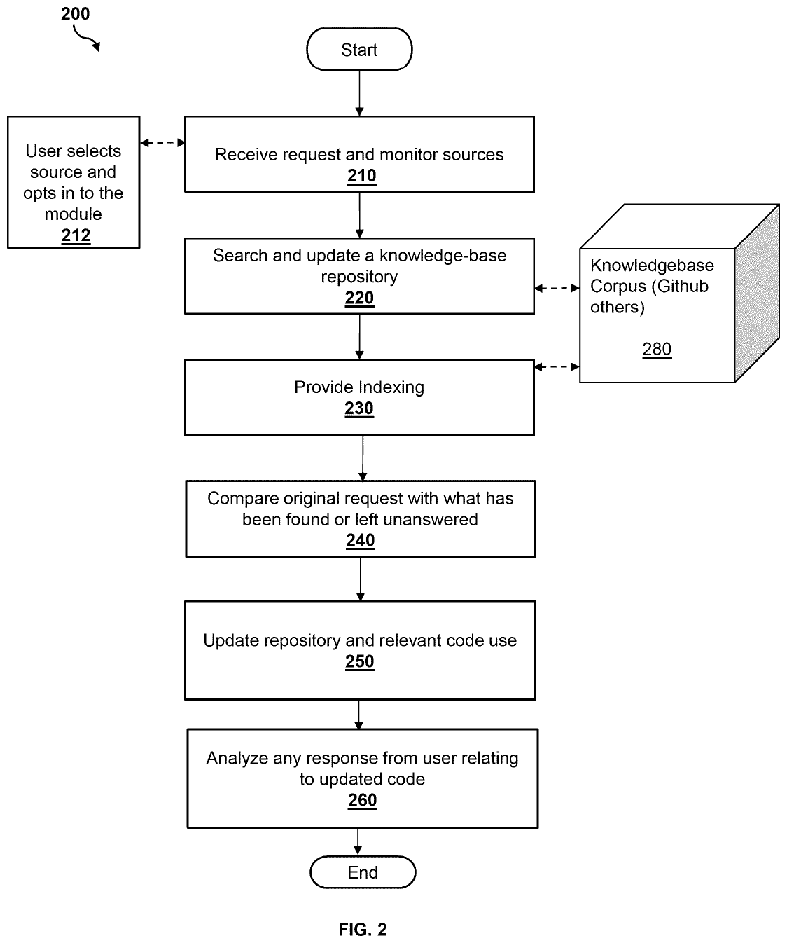

FIG. 2 provides a flowchart depiction of a process 200 that can lead to the establishment of a problem resolution and tracking technique. The process 200 has a plurality of steps as provided below.

In Step 210, a user request for a problem resolution may be received. The request may involve different alternate embodiments that include one or more sub-steps. For example, in one embodiment, the user nay have selected to opt in one or more forums or databases. These may be public or private and part of a computer network as provided in FIG. 1. The forums may be specific to providing and discussing a particular type of computer application, code release or other such related issues. This can be illustrated as a separate Step 212. A step can be provided to select a module (similar to 1200) to monitor one or more forums, databases, user groups or the like for a particular topic or solution or question. In one scenario, the request from the user can be processed using a natural language scan (e.g., natural language processing or NLP). NLP can also be used to scan one or more posts or forums. Other entries in the network (such as the cloud, across the Internet etc.) can also be monitored and scanned to find a similar questions, problem, solution, discussion or other related issue as relating to the topic of the interest to the user.

In Step 220, information can be also researched (or once found stored) in a knowledge-based corpus. If such a corpus has not been established, then one may be setup for future use. In one embodiment, the corpus may be comprised of one or more databases. The databases may provide specific tools. For example, in one embodiment, a code management tooling and repository database such as GitHub (or other code repositories) may be provided. The knowledge-based corpus has shown as reference numeral 280.

In Step 230, the information may be indexed. The source of information can be provided as well as additional and relevant components such as posting of the user or any associated questions. The resolutions (or at times information) requested by the user may then be analyzed and any unanswered portions may be highlighted. Association with one or more code-based forums or the like may also be provided and associated to the original user request.

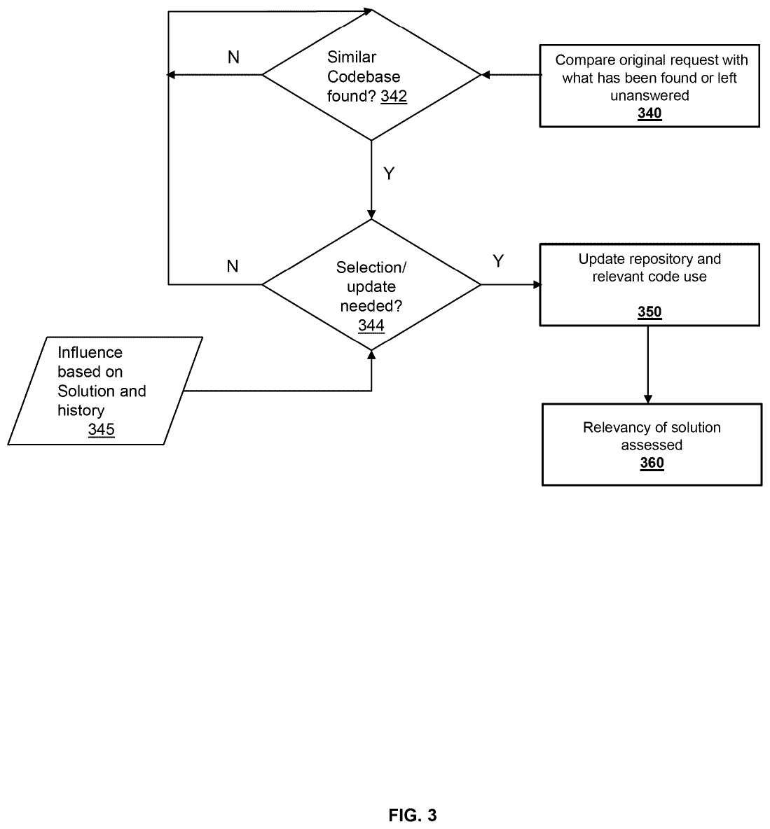

In Step 240, a comparison step may be performed where the date of the original user requested resolution/information may be updated against future posts that may be uploaded to a repository or a forum or the like (for example future GitHub codebases) as part of a future upgrade or release (as a part of an upload history). More information may be provided when discussing FIG. 3.

To provide ease of understanding, a scenario can be explored as is provided by example below, hut in other scenarios, alternate solutions can be enabled.
a. IF the code base is similar,
i. THEN it will be considered matching and processing will continue,
ii. ELSE the code base will not match and will not be utilized.
b. Is there a repository update after the post?
i. IF Yes, proceed to following steps below.
ii. IF No, Stop processing
c. NOTE: The influenced priority and searching accuracy is based on the post listed as “Solved.”

In Step 250, the processing continues but any updated and returned information from the repository or forums may be handled by reviewing and providing updates to the original resolution provided for the user problem. In addition, any other relevant code (even if incomplete and in chunk(s)/base as a plugin for manual developer code inspection) may also be processed and updated. The updates may be to the knowledge-based repository, and to the user who needed the information (user code can be automatically updated in one embodiment). This process would also allow for unique insight into the code inspection process on a timely basis.

In one embodiment, Step 250 may also include a code standard validity check. This may include the determination of code deployment environment (development, test, product etc.) and a follow up scan or assessment of security steps. The latter may be to ensure validity and quality of recommended code fix solution.

In addition, private repositories of storage can be anonymized. This may be especially important for some private or enterprise repositories, where users could be prompted to share non-confidential pieces of their solution to benefit others. This would prevent security and privacy issues.

In Step 260, in one embodiment, the user may be asked to respond to the relevancy of the updated code provided (even if it may be provided in chunks) based on the new codebase interaction. In one embodiment, this may even provide a better answer across the aggregated general population of knowledge developers through using a collective crowdsourced approach.

FIG. 3 provides a flowchart as an alternate embodiment to Steps 240 to 260. For ease of understanding, Steps 240 to 260 are similarly numbered as Steps 340 to 360.

Step 340 follows Step 230 of FIG. 2. In Step 230, the posting of the user and any unanswered questions relating to associated codebases were indexed in the knowledge-based corpus. In Step 340, the date of the post with future repositories (such as GITHUB is a trademark and brand of GitHub, Inc.) may be compared. Any relevant histories can be also uploaded.

In Step 242, a search may be made to determine whether there are different codebases with similar solutions. If a similar solution is found, then the process proceeds to step 344 where it is determined if a solution updated is needed. If a similar codebase is not found, the search will continue and there is no need for any updates, so no action is taken until a match has been found.

When a match is found, there is still a determination to be made if an update is suitable for the present code. An analysis of the current code can be made to determine if an update is needed and appropriate. If no update is needed, no action is taken but the code is further analyzed to see if one will be needed later. When an update is indicated as shown in block 350, an appropriate one will be provided. In one embodiment, once the solution is updated as in 350, the update can be stored (in the corpus/repository of 280).

In one embodiment, as shown in Step 344, the decision as to whether make an update or when one is appropriate, may also be provided by considering input from block 345. In one embodiment, for example, the input from 345 may examine related information about the priority history (Step 345) that will be provided to update a repository history storage of Step 344.

An update may include a variety of information ranging from accuracy of solution presented to number of posts that reveal the solution to be a “good” solution etc. This information will help in solution selection, if more than one exists in Step 344, and how much of it to be stored in the repository. It should be noted that as discussed in Step 344, the decision step selects when an update is relevant, Only when relevant if/fort—nation may be found, the step progresses to Step 350, where the relevant code, or alternatively chunk of code, may be provided to be part of the solution. In one embodiment, this can then be used as a base for a plugin or alternatively presented for manual developer inspection.

The process then proceeds to Step 360 where in this scenario, it may be allowed for an audience (developers, code drafter, users, readers etc.) to vote on the relevancy of the solution based on new codebase interactions to provide a potentially better answer to the solution.

It should be noted that the techniques of FIGS. 2 and 3 may also be provided using an artificial intelligence (AI) system and model (similar to module 1200) using machine learning algorithms. An example of a particular scenario may be provided below for ease of understanding. Again, this may only one scenario as can be appreciated by those skilled in the art and many alternate variations may be possible.

In one example, Devin is a developer who is working on providing a solution for a particular problem. Devin is developing the latest AI features for an intelligent workflow product. In one instance, a python script is erroring out when trying to predict the next best task for the next best workflow expert. The machine learning algorithm in the AI model has a code fault that prevents the model from executing and providing predictive recommendations.

In one scenario, this is a new differentiator for the product workflow that is time critical and essential for the next release of the product, With the current error, the feature will not be done in time for the next product release, offsetting recent marketing messaging and advantages over competitive offerings. Devin continuously tracks stack overflow and other code-related forums to see if anyone else has experienced this issue and identified a similar problem. Devin thinks he saw a post that shares the same issue but remembers there were no valid answers or code snippets that fully resolve the error. Using a module (similar to 1200), Devin is pointed to a forum that shared a similar problem. Very quickly, a thorough answer and code example are not provided on a forum, but the open-source project and link to the code repository is automatically provided to Devin through the code tracking module. Devin reviews the code, its effectiveness to fix the problem and the overall security of the solution to ensure it will work for the product. This enables the incorporation of a viable solution and design of a code fix. Devin uses the previous solution to provide a particular implementation. This may be a variation of the solution (open source or otherwise) in a more optimized and secure manner. This new hilly functional implementation enables the on-time release of the next product. This also resolves machine learning algorithm error so the AI model is fully functional and on-time for the next product release.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing a solution to a user problem, comprising:
receiving a request from a user for a resolution to a user problem;
obtaining a solution to a similar problem from a knowledge-based repository and identifying a source associated with said similar problem;
obtaining other solutions to said similar problem to said user problem from additional sources;
providing a final solution to said user problem by incorporating information obtained from said solutions to said similar problems obtained from said repository and said other sources;
providing a plurality of additional components in said final solution when said incorporated information does not provide a complete resolution to said user problem; and
identifying any related updates associated with said obtained solutions from said repository and/or said other sources and updating said final solution accordingly at a future date based on said identified updates associated with said obtained solutions.

2. The method of claim 1, wherein said other sources include a plurality of nodes in a computer network and posts on a forum.

3. The method of claim 1, wherein said incorporated information and/or additional components includes a plurality of codebases and chunks of applicable data.

4. The method of claim 3, wherein said related updates include capturing any associated codebases, and searching for a next iteration of said codebases.

5. The method of claim 4, wherein any updates identified to be added to said final solution are indexed and stored in said repository.

6. The method of claim 3, wherein differences between a codebase and a future iteration of a codebase associated applicable to said final solution are highlighted in said repository.

7. The method of claim 3, wherein one or more other users can upload a codebase solution of a push to said repository upon posting a resolution for said user's problem.

8. The method of claim 1, wherein said final solution is stored in said repository and said final solution and any associated solutions used in providing said final solutions are indexed in said repository for future use.

9. The method of claim 1, wherein said user problem is stored in said repository and an entry is also created in said repository when no similar problems or solutions are identified with said user problem in said repository or from other sources.

10. A computer system for providing a solution to a user problem, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system has a module enabled to perform the steps:
receiving a request from a user for a resolution to a user problem;
obtaining a solution to a similar problem from a knowledge-based repository and identifying a source associated with said similar problem;
obtaining other solutions to said similar problem to said user problem from additional sources;
providing a final solution to said user problem by incorporating information obtained from said solutions to said similar problems obtained from said repository and said other sources;
providing a plurality of additional components in said final solution when said incorporated information does not provide a complete resolution to said user problem; and
identifying any related updates associated with said obtained solutions from said repository and/or said other sources and updating said final solution accordingly at a future date based on said identified updates associated with said obtained solutions.

11. The computer system of claim 10, wherein said other sources include a plurality of nodes in a computer network and posts on a forum.

12. The computer system of claim 10, wherein said incorporated information and/or additional components includes a plurality of codebases and chunks of applicable data.

13. The computer system of claim 12, wherein said related updates include capturing any associated codebases, and searching for a next iteration of said codebases and any updates identified to be added to said final solution are indexed and stored in said repository.

14. The computer system of claim 12, wherein differences between a codebase and a future iteration of a codebase associated applicable to said final solution are highlighted in said repository.

15. The computer system of claim 12, wherein one or more other users can upload a codebase solution of a push to said repository upon posting a resolution for said user's problem.

16. The computer system of claim 10, wherein said final solution is stored in said repository and said final solution and any associated solutions used in providing said final solutions are indexed in said repository for future use.

17. The computer system of claim 10, wherein said user problem is stored in said repository and an entry is also created in said repository when no similar problems or solutions are identified with said user problem in said repository or from other sources.

18. A computer program product for providing a solution to a user problem, comprising: one or more computer-readable storage medium and program instructions stored on at least one of the one or more tangible storage medium, the program instructions executable by a processor, the program instructions comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps comprising:
receiving a request from a user for a resolution to a user problem;
obtaining a solution to a similar problem from a knowledge-based repository and identifying a source associated with said similar problem;
obtaining other solutions to said simile problem to said user problem from additional sources;
providing a final solution to said user problem by incorporating information obtained from said solutions to said similar problems obtained from said repository and said other sources;
providing a plurality of additional components in said final solution when said incorporated information does not provide a complete resolution to said user problem; and
identifying any related updates associated with said obtained solutions from said repository and/or said other sources and updating said final solution accordingly at a future date based on said identified updates associated with said obtained solutions.

19. The computer program product of claim 18, wherein said other sources include nodes in a computer network and posts on a forum and said incorporated information and/or additional components includes codebases and chunks of applicable data.

20. The computer program product of claim 18, wherein said related updates include capturing any associated codebases, and searching for a next iteration of said codebases and any updates identified to be added to said final solution are indexed and stored in said repository.
